(19) United States
(12) Patent Application Publication
(10) Pub. No.: US 2025/0002098 A1
(43) Pub. Date: Jan. 2, 2025

(54) TRANSPORT TRAILERS FOR RAISING AND TRANSPORTING DOLLIES

(71) Applicant: Toyota Motor Engineering & Manufacturing North America, Inc., Plano, TX (US)

(72) Inventors: Jeffrey M. Quick, Richmond, KY (US); Martin D. Murphy, Georgetown, KY (US); Daniel K. Claunch, Salvisa, KY (US); Garnett L. Hopkins, Millersburg, KY (US); Cody D. Williams, Georgetown, KY (US); Christopher A. Reeves, Lexington, KY (US); Noah A. Smith, Independence, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/216,777

(22) Filed: Jun. 30, 2023

(51) Int. Cl. B62D 53/08

(52) U.S. Cl. CPC B62D 53/0864; B60P 1/00

(57) ABSTRACT

A method of moving an autonomous mobile robot dolly is provided. The method includes positioning a base of a transport trailer under a frame of the autonomous mobile robot dolly. The base carries a lifting plate that is operatively connected to an actuator that is configured to raise the lifting plate. The lifting plate is raised using the actuator thereby raising the autonomous mobile robot dolly to a raised position. The transport trailer is moved from one location to a different location with the lifting plate and the autonomous mobile robot dolly in the raised position.

### TECHNICAL FIELD

The present specification generally relates to transport trailers, and more specifically to transport trailers for raising a transporting dollies.

### BACKGROUND

Autonomous mobile robots (AMRs) are frequently used to move around dollies in manufacturing environments, such as automobile manufacturing facilities. There are times when these AMRs are unresponsive and the dollies then need to be moved manually to their destination, which can be time-consuming.

Accordingly, a need exists for systems and methods for moving dollies.

### SUMMARY

In one embodiment, a method of moving an autonomous mobile robot dolly is provided. The method includes positioning a base of a transport trailer under a frame of the autonomous mobile robot dolly. The base carries a lifting plate that is operatively connected to an actuator that is configured to raise the lifting plate. The lifting plate is raised using the actuator thereby raising the autonomous mobile robot dolly to a raised position. The transport trailer is moved from one location to a different location with the lifting plate and the autonomous mobile robot dolly in the raised position.

In another embodiment, a transport trailer includes a base that includes a platform. One or more wheels are connected to the base. A lift assembly includes a lift plate that is carried by the base and an actuator connected to the base configured to lift the lift platform above the platform. The lift assembly is configured to lift an autonomous mobile robot dolly located on the lift platform to a raised position.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a schematic side view of a transport trailer with a lift assembly in a lowered position, according to one or more embodiments shown and described herein;

FIG. 2 depicts a schematic top view of the transport trailer of FIG. 1, according to one or more embodiments shown and described herein;

FIG. 3 depicts a schematic side view of the transport trailer of FIG. 1 in a raised position in use with the lift assembly placing an autonomous mobile robot dolly, according to one or more embodiments shown and described herein; and

FIG. 4 schematically depicts a method of moving an autonomous mobile robot dolly, according to one or more embodiments shown and described herein.

### DETAILED DESCRIPTION

A method of moving an autonomous mobile robot dolly includes positioning a base of a transport trailer under a frame of the autonomous mobile robot dolly. The base carries a lifting plate that is operatively connected to an actuator that is configured to raise the lifting plate. The lifting plate is raised using the actuator thereby raising the autonomous mobile robot dolly to a raised position. The transport trailer can then be moved from one location to a different location with the lifting plate and the autonomous mobile robot dolly in the raised position. For example, a tugger vehicle may be connected to the transport trailer using a hitch and be used to move the transport trailer from location to location. Such an arrangement can allow the autonomous mobile robot dolly to be moved in a motorized fashion without manually moving the autonomous mobile robot dolly.

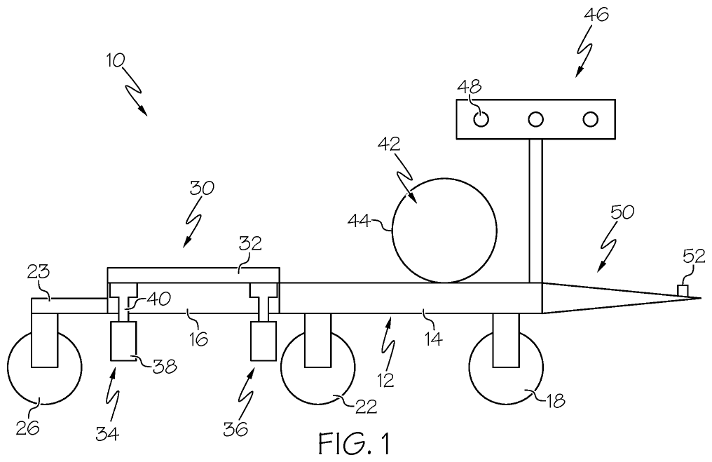

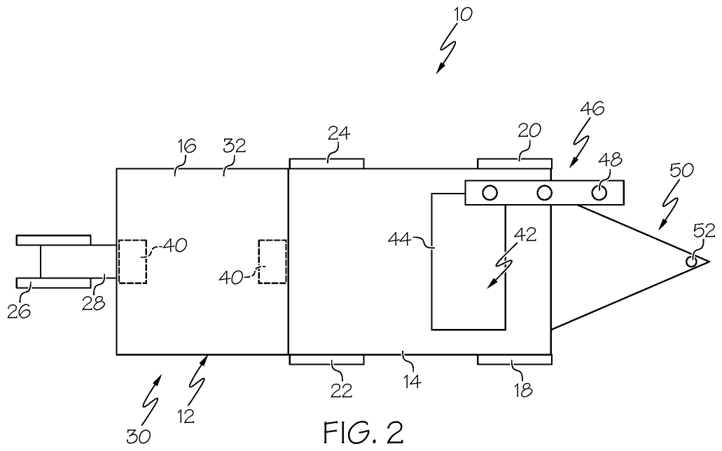

Referring to FIGS. 1 and 2, a transport trailer 10 includes a base 12 and may include a first platform 14 and a second platform 16 that are connected together side-by-side. In some embodiments, a narrower third platform 28 may be provided that is narrower in the trailer-lateral direction than the first platform 14 and the second platform 16. Wheels 18, 20, 22, 24 and 26 are connected to the base 12, which facilitate the transport trailer 10 being moved between locations on a floor of a facility, such as an automobile manufacturing assembly. While five wheels 18, 20, 22, 24 and 26 are illustrated, there may be more or less than five wheels 18, 20, 22, 24 and 26.

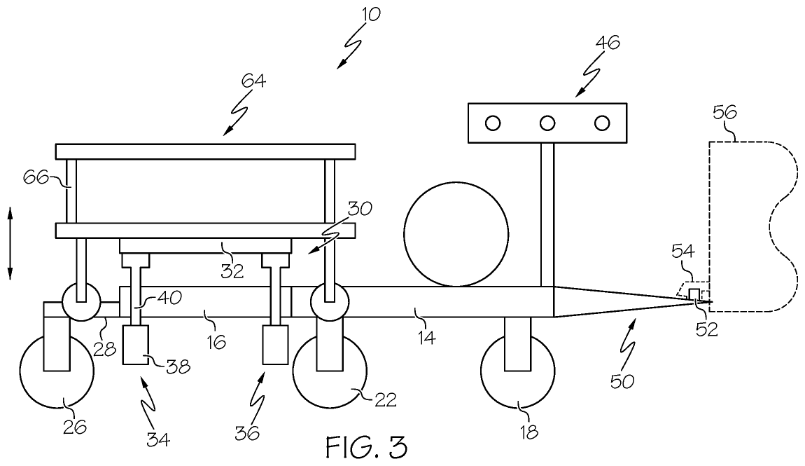

A lift assembly 30 is carried on the second platform 16. The lift assembly 30 includes a lift plate 32 that is connected to actuators 34 and 36. While two actuators 34 and 36 are shown, there may be less actuators, such as one, or more actuators, such as three or four actuators or more. In the illustrated example, the actuators 34 and 36 include a pneumatic cylinder 38 and a lift rod 40. An air source 42 may be operatively connected to the pneumatic cylinders 38 for actuating the lift rods 40. The air source 42 may include an air tank 44 that is provided on the first platform 14. A user input device 46 may also be provided on the first platform 14. The user input device 46 may include input elements 48, such as buttons and/or switches, that can be used to control the delivery of air from the air source 42 to the pneumatic cylinders 38 and the lifting and lowering of the lift plate 32 using the actuators 34 and 36. A hitch portion 50 of the base 12 may be provided with a hitch 52 that can be connected to a cooperating hitch 54 of a tugger vehicle 56 (FIG. 3).

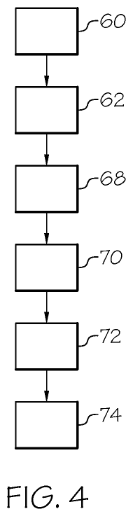

FIGS. 3 and 4 illustrate operation of the transport trailer 10. At step 60, it may be determined that an autonomous mobile robot is no longer operating and/or is not responding to communications. As used herein, an “autonomous mobile robot” refers to a type of robot that has autonomous capabilities and can understand and move through the environment independently. At step 62, an autonomous mobile robot dolly 64 may be removed from the autonomous mobile robot and positioned such that the second platform 16 and lift assembly 30 can be positioned beneath a frame 66 of the autonomous mobile robot dolly 64. The frame 66 is configured to mate with the autonomous mobile robot. Once the second platform 16 and lift assembly 30 are positioned beneath the frame 66, at step 68, an operator may actuate the actuators 34 and 36 by using the user input device 46 to cause pressurized air to be delivered from the air source 42 to the pneumatic cylinders 38. Delivering the pressurized air to the pneumatic cylinders 38 causes the lift rods 40 and the lift plate 32 to raise at step 70. At step 72, the autonomous mobile robot dolly 64 is lifted with the lift plate 32 to a raised position off of the floor and the tugger vehicle 56 can move the autonomous mobile robot dolly 64 in the raised position to another location without manually moving the autonomous mobile robot dolly 64 to that location at step 74.

The above-described transport trailers and methods of operation provide ways to move an autonomous mobile robot dolly from one location to another location when the autonomous mobile robot moving the autonomous mobile robot dolly is no longer responsive without having to manually move the autonomous mobile robot dolly to the next location. Manually moving the autonomous mobile robot dolly can take multiple people and be time-consuming. The above-described transport trailers and methods can reduce the amount of people needed and can reduce the time to move the autonomous mobile robot dolly.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of moving an autonomous mobile robot dolly, the method comprising:
positioning a base of a transport trailer under a frame of the autonomous mobile robot dolly, the base carrying a lifting plate that is operatively connected to an actuator that is configured to raise the lifting plate;
raising the lifting plate using the actuator thereby raising the autonomous mobile robot dolly to a raised position; and
moving the transport trailer from one location to a different location with the lifting plate and the autonomous mobile robot dolly in the raised position.

2. The method of claim 1 further comprising determining that an autonomous mobile robot is unresponsive.

3. The method of claim 2 further comprising moving the autonomous mobile robot dolly away from the autonomous mobile robot.

4. The method of claim 1, wherein the actuator comprises a pneumatic cylinder and a lift rod.

5. The method of claim 4 further comprising using a user input device to provide pressurized air to the pneumatic cylinder.

6. The method of claim 1, wherein the step of moving the transport trailer comprises moving a tugger vehicle that is connected to the transport trailer.

7. A system comprising:
an autonomous mobile robot dolly configured to mate with an autonomous mobile robot; and
a transport trailer comprising:
a base comprising a platform;
one or more wheels connected to the base; and
a lift assembly comprising a lift plate carried by the base and an actuator connected to the base configured to lift the lift platform above the platform;
wherein the lift assembly is configured to lift the autonomous mobile robot dolly located on the lift platform to a raised position.

8. The system of claim 7, wherein the platform is a first platform, the base comprising a second platform adjacent the first platform.

9. The system of claim 8, wherein the lift plate is on the second platform, an air tank carried by the first platform.

10. The system of claim 9, wherein the actuator comprises an air cylinder, the air tank operatively connected to the air cylinder.

11. The system of claim 1 further comprising a user input device that is configured to control operation of the actuator.
